(19) United States
(12) Patent Application Publication
(10) Pub. No.: US 2026/0260485 A1
(43) Pub. Date: Sep. 3, 2026

(54) METHOD AND SYSTEM FOR COLLECTING DATA ON A FIELD USED FOR AGRICULTURE

(71) Applicant: Bayer Aktiengesellschaft, Leverkusen (DE)

(72) Inventors: Matthias Tempel, Leverkusen (DE); Josef Exler, Leverkusen (DE)

(21) Appl. No.: 18/707,768

(22) PCT Filed: Nov. 4, 2022
(86) PCT No.: PCT/EP2022/080785

§ 371 Date: May 6, 2024

(30) Foreign Application Priority Data
Nov. 8, 2021 (EP) 21206921.5

(51) Int. Cl. G06V 20/10; A01B 79/00; G01S 19/42; G06T 7/00; G06V 20/17

(52) U.S. Cl. CPC G06V 20/188; A01B 79/005; G01S 19/42; G06T 7/0012; G06V 20/17; G06T 2207/10032; G06T 2207/30188

(57) ABSTRACT

The invention relates to a method for collecting data on a field used for agriculture by combining flying remote and ground level sensing, wherein, in a first step, by means of ground level sensing at reference points on the field used for agriculture, the geographical position of the respective reference point is captured and at least one photographic recording of at least one weed on the field used for agriculture is made for each reference point; in a second step, flying remote sensing parameters are determined on the basis of the data from an image analysis of the photographic recordings of the at least one weed for each reference point; and, in a third step, at least the reference points on the field used for agriculture are photographically captured by means of flying remote sensing, wherein at least some of the flying remote sensing parameters determined in step b) are used for the flying remote sensing.

### INTRODUCTION

The present invention relates to a method and a system for collecting data on a field used for agriculture by a combination of remote flying and ground level sensing, in particular for detecting weeds. The present invention also comprises a computer program product.

### BACKGROUND OF THE INVENTION

Precision agriculture presently allows the herbicide expenditure on a field used for agriculture to be reduced by subplot-specific herbicide application and nonetheless good weed control to be maintained. One possible approach for generating the weed distribution maps necessary for subplot-specific herbicide application is object-based analysis of geo-referenced image data using models of machine learning. The image data are often acquired here by means of remote flying sensing and in particular by using drones (unmanned aerial vehicle; UAV) and camera systems fastened or integrated on the drones. The image data are then verified using reference data, which have been obtained by ground level sensing. Various problems arise in this procedure, since the acquisition of reference data can be complex and/or subjective, for example. The verification of the image data using the reference data can also have the result that the image data are not suitable for generating the weed distribution maps and have to be acquired once again. Overall, it is therefore desirable to improve the data acquisition and the weed detection on a field used for agriculture and in particular the creation of weed distribution maps as a whole or at least to optimize or simplify individual steps which are necessary for this purpose.

### SUMMARY OF THE INVENTION

In view of the described starting position, it was a stated object of the present invention to further improve the existing digital methods and systems for data acquisition and weed detection on a field used for agriculture, in particular with regard to the creation of weed distribution maps, which are necessary for subplot-specific herbicide application.

In a first embodiment, the object is achieved by a method for collecting data on a field used for agriculture by a combination of remote flying and ground level sensing, wherein
a) in a first step, by ground level sensing at reference points on the field used for agriculture, the geographic position of the respective reference point is acquired and for each reference point at least one photographic recording is made of at least one weed on the field used for agriculture,
b) in a second step, remote flying sensing parameters are determined on the basis of the data of an image analysis of the photographic recordings of the at least one weed for each reference point,
c) in a third step, at least the reference points on the field used for agriculture are photographically acquired by remote flying sensing, wherein the remote flying sensing parameters determined in step b) are at least partially used for the remote flying sensing.

In other words, reference data of a weed or of weeds are first collected by ground level sensing by the method for collecting data on a field used for agriculture. The reference data are used, inter alia, to derive remote flying sensing parameters and thus ensure that the remote flying sensing can supply image data which have a high quality and which are suitable, for example, for the creation of a weed distribution map. An optimum acquisition of the remote flying sensing data is enabled and a collection of unusable data is minimized by this procedure. This results in efficiency increases and cost savings.

In one example, in the first step a), at least one reference point is selected on which a weed grows.

In other words, the image analysis of the photographic recording in step b) is thus improved because precisely one weed is selected. This avoids, for example, multiple weeds located close to one another being acquired, in the case of which it is more probable that the image analysis in step b) will lead to incorrect results and possible consequential errors will result therefrom, for example in the determination of the remote flying sensing parameters.

In a further example, in the first step a), ground level sensing is carried out at at least 20 (twenty) reference points.

For a good determination of the remote flying sensing parameters and the later evaluation of the accuracy of the acquisition and/or determination of the weeds, it is necessary to collect data at a certain minimum number of reference points. In one example, the image analysis of the photographic recordings for each reference point in the second step b) comprises the determination of at least one weed and its size.

In one example, the image analysis in the second step b) comprises the determination of the weed type for the at least one weed.

In a further example, the remote flying sensing parameters are defined in the second step b) in that first the projected size of a single pixel of the smallest weed to be acquired on the ground (ground sampling distance, GSD) is determined.

In one example, the smallest weed to be acquired is determined on the basis of a size comparison of all identified weeds from the image analysis of the photographic recordings for each reference point.

In other words, it is possible by way of this procedure to identify weeds in an early stage of growth even using remote flying sensing, because the smallest weeds to be acquired on the field used for agriculture are used as a measure for the determination of the remote flying sensing parameters.

In one example, the remote flying sensing parameters comprise the altitude and the camera properties and are determined on the basis of the projected size of a single pixel of the smallest weed to be acquired on the ground (GSD).

In one example, the image analysis of the photographic remote flying sensing data in the fourth step d) comprises the determination of at least one weed.

In one example, in a fourth step d), at least one weed distribution map is created for the field used for agriculture by means of an image analysis of the photographic remote flying sensing data.

In one example, in the fourth step d), the accuracy of the at least one weed distribution map is determined by comparison of the image analysis of the photographic remote flying sensing data and the image analysis of the ground level sensing data at the reference points.

In a further example, the comparison of the image analysis of the photographic remote flying sensing data and the image analysis of the ground level sensing data at the reference points in the fourth step d) takes place in that it is checked whether at least one weed has been detected at the same geographic position of a reference point both in the image analysis of the photographic remote flying sensing data and in the image analysis of the photographic ground level sensing data.

In other words, after the remote flying sensing and the creation of the weed distribution map, a validation is carried out using the data which have been collected at the reference points. It is thus possible to determine the accuracy and thus the quality of the weed distribution map. It can therefore also be determined whether the weed distribution map is suitable for a subplot-specific herbicide application on the field used for agriculture.

A further embodiment relates to a system for collecting data on a field used for agriculture by a combination of remote flying and ground level sensing, comprising:
at least one measuring rod;
a receiving unit;
a computing unit; and
an output unit;
   wherein, with the aid of the at least one measuring rod by ground level sensing, the geographic position of individual reference points on a field used for agriculture is acquired and for each reference point at least one photographic recording is made of at least one weed on the field used for agriculture,
wherein the data from the reference points are provided to the computing unit via the receiving unit,
wherein the computing unit is configured to carry out an image analysis of the photographic data of the respective reference points and to determine at least one weed for each reference point,
wherein the computing unit is configured to determine remote flying sensing parameters on the basis of the image analysis,
wherein the output unit is configured to display, output, or store in a data memory at least the information from the computing unit with respect to the determination of remote flying sensing parameters.

A further embodiment relates to a computer program product for controlling the above-described system, which is configured to carry out the above-described method upon execution by a processor.

A further embodiment relates to a measuring rod for collecting data by ground level sensing on a field used for agriculture, comprising:
at least one rod;
a sensor for determining the geographic position of individual reference points on the field used for agriculture;
a camera for photographically acquiring at least one weed for each reference point;
an output unit;
wherein the sensor for determining the geographic position and the camera are positioned on or at the rod so that the geographic position and the photographic recording can be determined or made at a reference point at the same point in time.

In other words, it is possible by way of such a measuring rod to collect the required data for a reference point on the field used for agriculture quickly and accurately. Measurement errors or inaccuracies can thus be minimized or precluded.

### BRIEF DESCRIPTION OF THE FIGURES

Embodiments of the invention will be described below by reference to the following figures:

FIG. 1 schematically shows step a) of the method for collecting data on a field used for agriculture.

FIG. 2 schematically shows step b) of the method for collecting data on a field used for agriculture.

FIG. 3 schematically shows step c) of the method for collecting data on a field used for agriculture.

FIG. 4 schematically shows step d) of the method for collecting data on a field used for agriculture and in particular the creation of at least one weed distribution map.

FIG. 5 schematically shows step d) of the method for collecting data on a field used for agriculture and in particular the determination of the accuracy of the at least one weed distribution map.

FIG. 6 shows specific examples of the determination of the accuracy of the at least one weed distribution map.

FIG. 7 schematically shows a system for collecting data on a field used for agriculture.

FIG. 8 schematically shows three possible embodiments of a measuring rod for collecting data by ground level sensing on a field used for agriculture.

### DETAILED DESCRIPTION

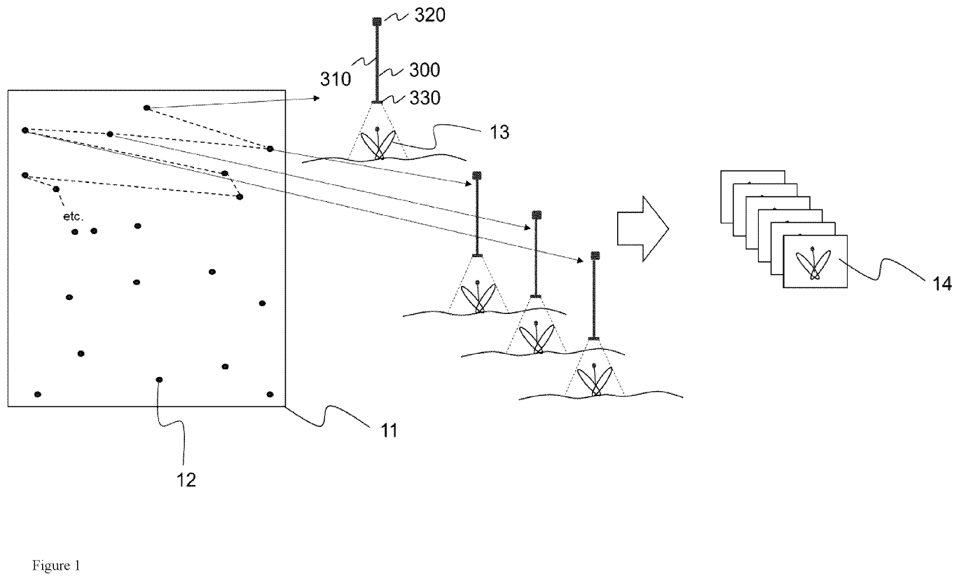

FIGS. 1 to 3 schematically show a method 10 for collecting data on a field used for agriculture by a combination of remote flying and ground level sensing, wherein
a) in a first step, by ground level sensing at reference points on the field used for agriculture, the geographic position of the respective reference point is acquired and for each reference point at least one photographic recording is made of at least one weed on the field used for agriculture,
b) in a second step, remote flying sensing parameters are determined on the basis of the data of an image analysis of the photographic recordings of the at least one weed for each reference point,
c) in a third step, at least the reference points on the field used for agriculture are photographically acquired by remote flying sensing, wherein the remote flying sensing parameters determined in step b) are at least partially used for the remote flying sensing.

In one example, the method for collecting data on the field used for agriculture by a combination of remote flying and ground level sensing comprises the detection of weeds.

FIG. 1 schematically shows step a) of the method 10. Data are collected on the field 11 used for agriculture at reference points 12 by ground level sensing. The field 11 used for agriculture is shown in FIG. 1 from a bird's eye perspective. For each reference point 12, the geographic position is acquired. In addition, for each reference point 12, at least one photographic recording 14 is made of at least one weed 13 on the field 11 used for agriculture. A measuring rod 300 can be used for this data collection, for example. The measuring rod comprises, for example, a sensor 320 for determining the geographic position of individual reference points 12 and a camera 330 for photographic acquisition 14 of at least one weed 13 for each reference point 12. In FIG. 1, data are collected at 20 (twenty) reference points 12 on the field 11 used for agriculture, so that the data collection comprises twenty photographic recordings and the respective geographic position of the photographic recordings.

In one example, at least one reference point is selected, on which a weed grows.

In one example, at least one reference point is selected, on which a single weed plant grows.

In a further example, the geographic position is determined by a positioning system. A known positioning system is a satellite navigation system such as, for example, NAVSTAR GPS, GLONASS, Galileo or Beidou. Since the abbreviation GPS (Global Positioning System) is now colloquially used as the generic term for all satellite navigation systems, the term GPS will be used in what follows as the collective term for all positioning systems. The use of an RTK (real-time kinematic) GPS positioning system is particularly preferred. Accuracies of 1 to 2 cm are achieved in this case. The coordinates of the points can be calculated in real time after the initialization.

In one example, in the first step a) of the method, ground level sensing is carried out at at least (twenty) 20, preferably (thirty) 30, and even more preferably (fifty) 50, reference points.

In one example, in the first step a) of the method, the at least one photographic recording of the field used for agriculture is made for each reference point using the same working distance and preferably using the same camera properties. In one example, the camera properties relate to the sensor size, the sensor resolution, and/or (preferably “and”) the focal length.

In a further example, the determination of the geographic position and the photographic recording at a reference point are carried out at the same point in time.

In one example, the term “ground level sensing” relates to the inspection of the field used for agriculture and the collection of data in a ground level range, for example at a distance from the ground of at most 2 m, preferably of at most 1 m.

In one example, the term “reference point” relates to a narrowly bounded area on a field used for agriculture. The reference points can be selected randomly. Only at least one weed has to grow at a reference point. A geographic position can be determined for each reference point. For example, a reference point comprises an area of 20 cm², preferably 10 cm², and even more preferably 5 cm².

In one example, a “photographic recording” (or a “photographic acquisition”) is understood as a data acquisition using a camera, for example in 2D. The camera comprises an image sensor which is suitable for acquiring individual weeds on the field in a good resolution. For example, a camera of a mobile telephone can be used. In one example, the camera is configured so that it can acquire photographic recordings in the visible wavelength range.

In one example, the camera is configured so that it can acquire items of color information (RGB).

In one example, the term “weed” refers to plants which occur as spontaneous “accompanying vegetation” on the field used for agriculture, which are not deliberately cultivated there and develop from the seed potential of the ground, via root suckers, or via seeds flying in. Weeds can be monocot or dicot plants.

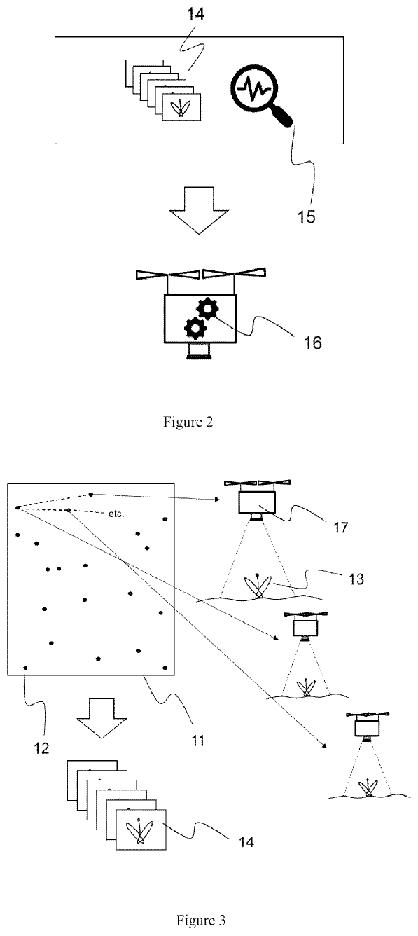

FIG. 2 schematically shows step b) of the method for collecting data on a field used for agriculture. Remote flying sensing parameters 16 are determined on the basis of an image analysis 15 of the photographic recordings 14 of all reference points 12.

In one example, the image analysis of the photographic recordings for each reference point in the second step b) comprises the determination of at least one weed and its size.

In one example, the determination of the size of the at least one weed comprises the determination of the area and the diameter of the at least one weed.

In one example, the image analysis comprises the determination of the weed type for the at least one weed.

In one example, the image analysis comprises the determination of the BBCH growth stage for the at least one weed. The BBCH growth stage is preferably determined visually by the image analysis. The BBCH code (or also: the BBCH scale) provides information about the morphological development stage of a plant.

In one example, the determination of the at least one weed and its properties is carried out by means of instance segmentation, preferably using artificial intelligence and even more preferably using a convolutional neural network and even more preferably a “region based convolutional neural network” (R-CNN). Instance segmentation and the use of R-CNN for determining weeds is known to a person skilled in the art, see, for example, Julien Champ et al., Instance segmentation for the fine detection of crop and weed plants by precision agricultural robots, Applications in Plant Sciences 2020 8/7); e11373.

In one example, the remote flying sensing parameters are defined in the second step b) in that first the projected size of a single pixel of the smallest weed to be acquired on the ground (ground sampling distance, GSD) is determined.

In one example, for the size comparison of all identified weeds, the weed type and preferably also the BBCH growth stage of the individual weeds is also considered.

In one example, for the value for the smallest weed to be acquired, a threshold value is used or the value is adapted to a threshold value. For example, a threshold value can be determined, for specific weeds such as thistles, of 2 cm, because the plants cannot be detected by the image analysis of remote flying sensing data at a plant size below 2 cm.

In one example, the remote flying sensing parameters comprise the altitude and the camera properties and these are determined on the basis of the projected size of a single pixel of the smallest weed to be acquired on the ground (GSD).

In one example, the camera properties comprise the sensor size, the sensor resolution, and/or (preferably “and”) the focal length.

In one example, the remote flying sensing parameters comprise the geographic position of the reference points.

In a further example, remote flying sensing parameters are determined which ensure the detection of the weeds and at the same time maximize the area output of the remote sensing. In one example, the following formula is used for this purpose: “Large plants in mm/2*correction factor for light * correction factor for flight conditions”. The correction factor for light takes into consideration, for example, the time of day/season or the weather conditions (sunny, slightly cloudy, etc.). The correction factor for flight conditions takes into consideration, for example, turbulent wind conditions which have effects on the camera shutter speeds, the overlap of the photographic recordings, or also the flight speed. The correction factors thus compensate for the image fuzziness. The adaptation can take place in the preliminary stage, also immediately before the flight on the basis of the weather prediction at the location.

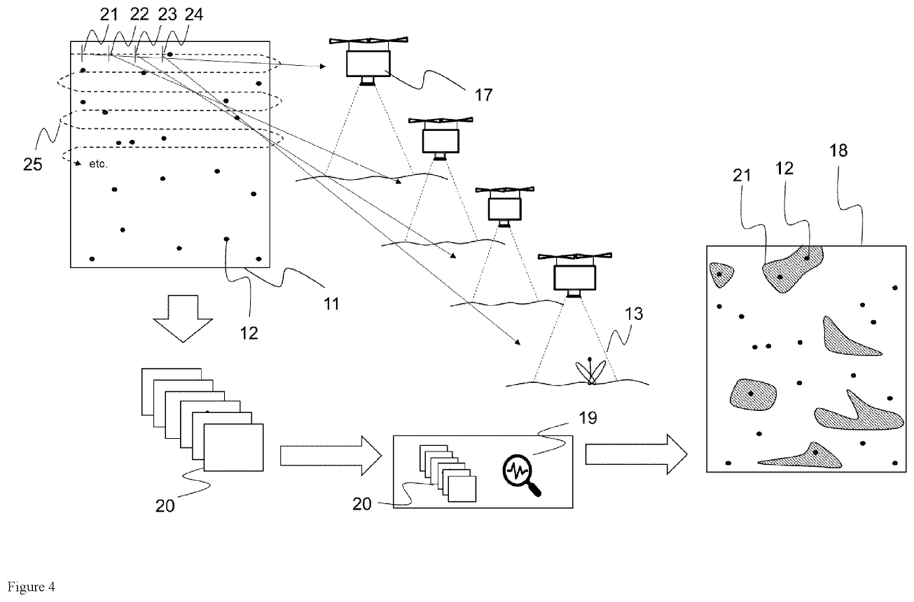

FIG. 3 schematically shows step c) of the method for collecting data on a field used for agriculture. At least the reference points 12 are photographically 14 acquired on the field 11 used for agriculture by remote flying sensing. In FIG. 3, the aircraft 17 is shown by way of example as a drone having a camera which can be used for the remote flying sensing. The remote flying sensing parameters 16 determined in step b) are at least partially used for the remote flying sensing.

In one example, the entire area comprised by the reference points is photographically acquired.

In a further example, the entire field used for agriculture is photographically acquired by remote flying sensing. The photographic acquisition of the entire field is necessary for generating a suitable weed distribution map.

The remote flying sensing parameters determined in step b), such as the altitude and the camera properties, are at least partially used for the remote flying sensing. In addition, there are further remote flying sensing parameters, such as the selection of the aircraft, the flight route, etc., which have to be taken into consideration.

In one example, at least one unmanned aircraft (unmanned aerial vehicle, UAV) is used in step c) for the remote flying sensing. Multiple aircraft can also be used.

In one example, cameras integrated in aircraft or fixable on aircraft are used for the photographic recordings of the remote flying sensing. In particular the use of a high-resolution camera sensor is important for this purpose.

In one example, the image analysis of the photographic remote flying sensing data in the fourth step d) comprises the determination of at least one weed.

In one example, the image analysis of the photographic remote flying sensing data in the fourth step d) comprises the determination of the size of the at least one weed.

In one example, the determination of the size of the at least one weed comprises the determination of the area and the diameter of the at least one weed.

In one example, the image analysis of the photographic remote flying sensing data in the fourth step d) comprises the determination of the weed type for the at least one weed.

In one example, the image analysis of the photographic remote flying sensing data in the fourth step d) comprises the determination of the BBCH growth stage of the at least one weed. In one example, the determination of the at least one weed and its properties is carried out by means of instance segmentation, preferably using artificial intelligence and even more preferably using a convolutional neural network and in particular an R-CNN. As described above, such methods are known to a person skilled in the art.

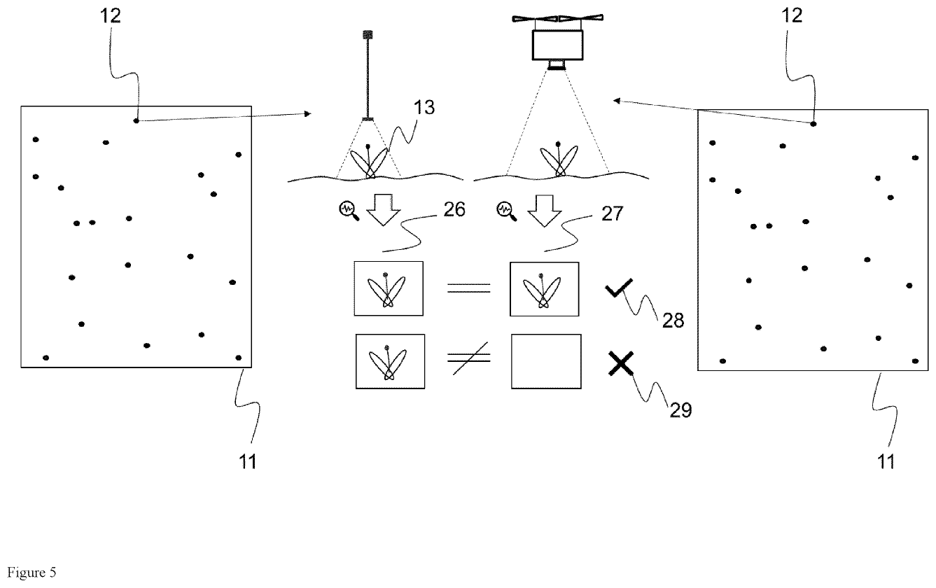

FIG. 4 schematically shows step d) of the method for collecting data on a field 11 used for agriculture and in particular the creation of at least one weed distribution map 18. The at least one weed distribution map 18 for the field 11 used for agriculture is created by means of an image analysis 19 of the photographic remote flying sensing data 20. The aircraft 17 (shown as a drone in FIG. 4) flies over the field 11 used for agriculture (see dashed line 25, which represents the flight route by way of example). The photographic acquisition 20 of the entire field 11 takes place at regular intervals 21, 22, 23, 24 (etc.). Overlapping photographic recordings 20 are preferably made here, which can be used for geo-referencing and possibly for orthorectification of the image data.

In one example, the creation of the at least one weed distribution map 18 is carried out on the basis of geo-referenced and preferably orthorectified photographic remote flying sensing data 20 and the image analysis 19 in which at least the weeds 13 are determined on the field 11 used for agriculture. Preferably, the size of the weeds 13 or in particular also the weed types of the individual identified weeds or the BBCH growth stage is also determined by the image analysis 19 as described above.

In one example, the weed distribution map 18 shows at least those areas 21 on the field 11 used for agriculture in which weeds 13 grow (shown as shaded areas 21 in FIG. 4). The white areas in the weed distribution map 18 in FIG. 4 show exemplary regions on the field used for agriculture where at the time of the data collection no weeds grow (or are too small). The weed distribution map 18 can also indicate more detailed data, such as the distribution and the occurrence of various weed types, the reference points 12, or the size or the BBCH growth stage of the individual weeds. Combinations of these data can also be represented.

FIG. 5 schematically shows step d) of the method for collecting data on a field 11 used for agriculture and in particular the determination of the accuracy of the at least one weed distribution map. The accuracy of the at least one weed distribution map is determined by comparison of the image analysis of the photographic remote flying sensing data 27 and the image analysis of the ground level sensing data 26 at the reference points 12.

In one example, the comparison of the image analysis of the photographic remote flying sensing data 27 and the image analysis of the ground level sensing data 26 at the reference points 12 in the fourth step d) takes place in that it is checked whether, at the same geographic position of a reference point 12, at least one weed 13 has been detected both in the image analysis of the photographic remote flying sensing data 27 and in the image analysis of the ground level sensing data 26. FIG. 4 shows at numbe 28 a scenario in which a weed has been detected in both image analyses. A scenario is represented at number 29 where a weed has only been detected in the image analysis of the ground level sensing data 27, but not in the image analysis of the remote flying sensing data 27. It is also possible that weeds are detected in both image analyses (26 and 27), however the weeds are different weed types.

In one example, the at least one weed distribution map for the field used for agriculture is used for the subplot-specific application of at least one weed control agent. All known herbicides on a biological and/or chemical basis can be used as weed control agents.

In one example, the subplot-specific application of a weed control agent according to the weed distribution map is carried out by a tractor having a plant protection sprayer.

In one example, the determination of the weed type in step d) can be used to determine which at least one weed control agent is to be used. In one example, different weed control agents can be used for different weeds.

In one example, a field crop, preferably selected from the group of corn, sugar beets, grains, and soybeans, is or has been planted on the field used for agriculture.

In a further example, the accuracy of the at least one weed distribution map in the fourth step d) is sufficient if, with respect to all reference points acquired by ground level sensing, at least one weed has been detected at least in 95% (preferably at least in 96.5% and even more preferably in 98%) of the comparisons at the geographic position of a reference point both in the image analysis of the photographic remote flying sensing data and in the image analysis of the ground level sensing data. Preferably, at least one weed which is of the same weed type is detected in this comparison in both image analyses.

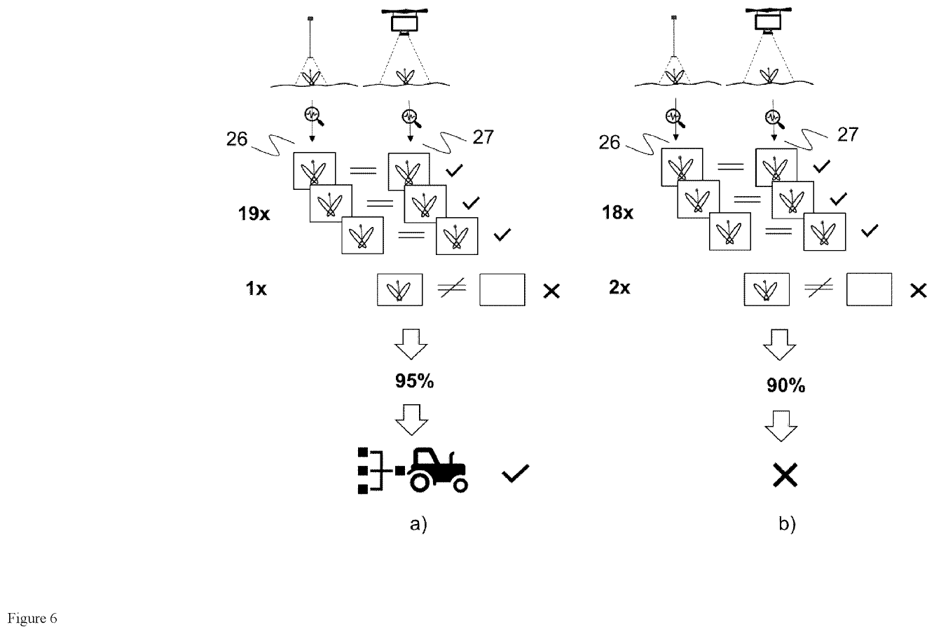

FIG. 6 shows specific examples of the determination of the accuracy of the at least one weed distribution map. An example a) is shown on the left side of FIG. 6, in which ground level sensing data and remote flying sensing data have been collected at twenty reference points and at least one weed distribution map has been determined by the described method. The comparisons of the image analysis of the photographic remote flying sensing data 27 to the image analysis of the ground level sensing data 26 for each reference point had the result that at least one weed was detected at 19 reference points in both data sets. At one reference point, a weed was only detected in the image analysis of the ground level sensing data 26, but not in the image analysis of the remote flying sensing data 27. Overall, an accuracy of the weed distribution map of 95% results for this example, which is sufficient to use the at least one weed distribution map for a subplot-specific application of at least one weed control agent. A further example b) is shown on the right side of FIG. 6, in which ground level sensing data and remote flying sensing data have been collected at twenty reference points and at least one weed distribution map has been determined by the described method. The comparisons of the image analysis of the photographic remote flying sensing data 27 to the image analysis of the ground level sensing data 26 for each reference point had the result that at least one weed was detected at 18 reference points in both data sets. At two reference points, a weed was only detected in the image analysis of the ground level sensing data 26, but not in the image analysis of the remote flying sensing data 27. Overall, an accuracy of the at least one weed distribution map of 90% results for this example, which is not sufficient to use the at least one weed distribution map for a subplot-specific application of at least one weed control agent.

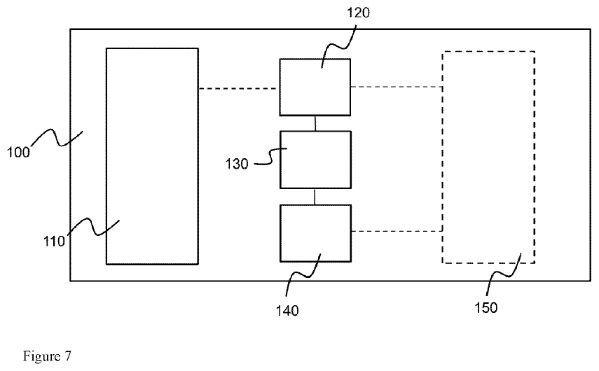

FIG. 7 schematically shows a system 100 for collecting data on a field used for agriculture by a combination of remote flying and ground level sensing. The system comprises at least one measuring rod 110, a receiving unit 120, a computing unit 130, and an output unit 140. With the aid of the at least one measuring rod, the geographic position is acquired at individual reference points on a field used for agriculture by ground level sensing and at least one photographic recording of at least one weed on the field used for agriculture is made for each reference point. The data from the reference points are provided to the computing unit via the receiving unit. The computing unit is configured to carry out an image analysis of the photographic data from the respective reference points and determine at least one weed for each reference point. The computing unit is furthermore configured to determine remote flying sensing parameters on the basis of the image analysis. The output unit is configured to display, output, or store in a data memory at least the information from the computing unit relating to the determination of remote flying sensing parameters.

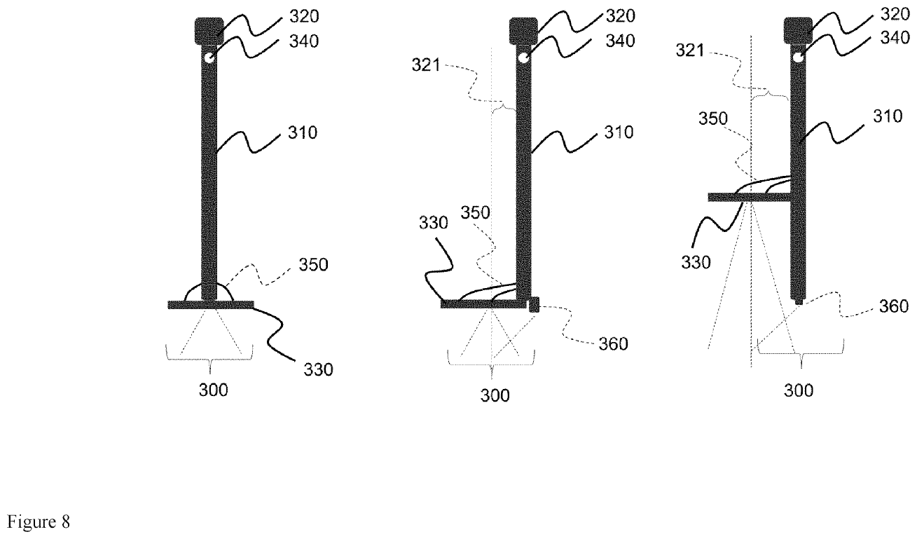

In one example, the system comprises the measuring rod described in more detail by FIG. 8.

In one example, the data are transmitted from the measuring rod 110 to the receiving unit 120 by various transmission technologies known per se to a person skilled in the art, for example in a wired or wireless manner, for example via networks such as PAN (e.g., Bluetooth), LAN (e.g., Ethernet), WAN (e.g., ISDN), GAN (e.g., the Internet), LPWAN or LPN (such as, for example, SigFox, LoRAWAN, etc.), cellular networks or others.

The system comprises a receiving unit, a computing unit, and an output unit. It is conceivable that the mentioned units are components of a single computer system, but it is also conceivable that the mentioned units are components of a plurality of separate computer systems that are connected to one another via a network in order to transmit data and/or control signals from one unit to another unit. It is, for example, possible for the computing unit to be in the “cloud” and for the analysis steps described in this application to be carried out by this computing unit in the “cloud”. A “computer system” is an electronic data processing system that processes data by means of programmable calculation rules. Such a system typically comprises a “computer”, which is the unit that includes a processor for carrying out logic operations, and peripherals. In computer technology, “peripherals” refers to all devices that are connected to the computer and are used for control of the computer and/or as input and output devices. Examples thereof are monitor (screen), printer, scanner, mouse, keyboard, drives, camera, microphone, speakers, etc. Internal ports and expansion cards are also regarded as peripherals in computer technology. Modern computer systems are frequently divided into desktop PCs, portable PCs, laptops, notebooks, netbooks and tablet PCs, and what are called handhelds (for example smartphones); all of these systems may be used to implement the invention.

The computing unit 130 is configured to carry out step b) of the method described above in detail—including all preferred embodiments thereof.

In one example, the system comprises at least one aircraft 150. The aircraft preferably comprises a data receiving and transmitting unit. The aircraft is preferably at least one unmanned aircraft (unmanned aerial vehicle, UAV). Multiple aircraft can also be used.

In one example, the output unit is configured to transmit at least the information from the computing unit with respect to the determined remote flying sensing parameters to the at least one aircraft by means of the above-described transmission technologies, which are known to a person skilled in the art as such.

In a further example, the at least one aircraft 150 is configured to carry out step c) of the method described above in detail—including all preferred embodiments thereof.

In a further example, the data of the remote flying sensing are provided by the aircraft 150 via the receiving unit 120 to the computing unit 130.

In one example, the computing unit 130 is configured to carry out step d) of the method described above in detail—including all preferred embodiments thereof. I.e., the computing unit can carry out the image analysis of the remote flying sensing data, create at least one weed distribution map of the field used for agriculture, and/or check the accuracy of the weed distribution map.

In one example, the weed distribution map generated by the computing unit 130, preferably after checking the accuracy of the weed distribution map, is provided by the output unit 140 to the receiving unit of a tractor having a plant protection sprayer. The tractor having a plant protection sprayer is configured to carry out a subplot-specific application of a weed control agent according to the weed distribution map on the field used for agriculture.

Further embodiments of the invention relate to a computer program product for control of the above-described system, which, upon execution by a processor, is configured in such a way as to carry out the above-described method. A further embodiment relates to a storage medium which has stored the computer program product.

FIG. 8 schematically shows three possible embodiments a) to c) of a measuring rod 300 for collecting data by ground level sensing on a field used for agriculture. The measuring rod 300 comprises at least one rod 310; a sensor 320 for determining the geographic position of individual reference points on a field used for agriculture; a camera 330 for photographically acquiring at least one weed for each reference point; and an output unit 340. The sensor for determining the geographic position and the camera are positioned on or at the rod so that the geographic position and the photographic recording at a reference point can be determined or made at the same point in time.

In one example, the rod 310 is a plumb rod.

In one example, the sensor 320 is a positioning system and in particular a satellite navigation system such as NAVSTAR GPS, GLONASS, Galileo, or Beidou. The use of an RTK (real-time kinematic) GPS positioning system is particularly preferred.

In one example, the camera 330 comprises an image sensor, which is suitable for acquiring individual weeds on the field in a good resolution. For example, a camera of a mobile telephone can be used. In one example, the camera is configured so that it can acquire photographic recordings in the visible wavelength range. In one example, the camera is configured so that it can acquire items of color information (RGB). In one example, the camera acquires photographic recordings in 2D.

In one example, the output unit 340 comprises a transmitting unit.

In one example, the transmitting unit is configured to transmit the data from the sensor 310 and/or (preferably “and”) the camera 330 via the above-described transmission technologies known per se, for example in a wired or wireless manner, to other devices. In one example, two independent output units 340 are provided for the transmission of the geographic position data and for the transmission of the image data.

In one example, the camera is located at the lower end of the rod 310, preferably at a right angle to the rod (as shown in FIG. 8 a)). The camera can in this position photographically record the at least one weed from above (in the extension of the plumb direction of the rod downward, nadir position.) In one example, the measuring rod 300 comprises a camera mount 350. The camera mount is configured to fix the camera on the rod firmly but preferably reversibly.

In one example, the measuring rod 300 comprises a laser pointer 360 (see also FIG. 8b) and FIG. 8c)). The laser pointer is configured to irradiate the at least one weed on the field used for agriculture. It can thus be ensured that the geographic position and the photographic acquisition can take place in a synchronized manner at precisely the exact location.

The sensor 320, the camera 330, and the laser pointer 360 are therefore preferably synchronized. In FIG. 8b), the camera 330 is located, for example, laterally at the bottom of the rod 310. The recording area of the camera is shown by dashed lines. The laser pointer 360 is also located in the lower area of the rod. Its laser light (dashed line) is directed onto the center of the recording area of the camera 330. The determination of the geographic position, i.e., where the laser irradiates the at least one weed, is slightly offset in comparison to the plumb direction of the measuring rod (see 321). This difference in the geographic position of the weed to be acquired and the sensor 320 is compensated in the determination of the exact geographic position of the weed to be acquired via a correction factor. This also applies to the embodiment of FIG. 8c), in which the camera 300 is fastened laterally (and preferably at a right angle to the rod) farther up the rod 310 using a camera mount 350.

RTK-GPS surveying plumb rods are known in the prior art (e.g., ProMark 220 GNSS Ashtech from Spectra, GeoMax Zenitz 35 pro from Geometra) but are not suitable for photographically recording at least one weed at a reference point on a field used for agriculture and simultaneously surveying the geographic position. In the known measuring rods, such data collection takes place sequentially in any case, which can result in measurement errors. The measuring rod described in the application addresses this problem and offers a solution which is significantly less susceptible to error.

The invention has been explained without making a significant distinction between the subjects of the invention (method, system, computer program product, storage medium, measuring rod). On the contrary, the explanations are intended to apply analogously to all the subjects of the invention, independently of the context in which they are given.

Where steps are stated in an order in the present description or in the claims, this does not necessarily mean that the invention is limited to the order stated. Instead, it is conceivable that the steps are also executed in a different order or else in parallel with one another, the exception being when one step builds on another step, thereby making it imperative that the step building on the previous step be executed next (which will however become clear in the individual case). The orders stated are thus preferred embodiments of the invention.

1. A method for collecting data on a field used for agriculture by a combination of remote flying and ground level sensing, the method comprising:
a) in a first step, by ground level sensing at reference points on the field used for agriculture, the geographic position of a respective reference point is acquired and for each reference point at least one photographic recording is made of at least one weed on the field used for agriculture;
b) in a second step, remote flying sensing parameters are determined on the basis of data of an image analysis of the photographic recordings of the at least one weed for each reference point; and
c) in a third step, at least the reference points on the field used for agriculture are photographically acquired by remote flying sensing, wherein the remote flying sensing parameters determined in step b) are at least partially used for the remote flying sensing.

2. The method as claimed in claim 1, wherein, in the first step a), at least one reference point is selected on which a weed grows.

3. The method as claimed in claim 1, wherein, in the first step a), ground level sensing is carried out at at least 20 reference points.

4. The method as claimed in claim 1, wherein the image analysis of the photographic recordings for each reference point in the second step b) comprises a determination of at least one weed and its size.

5. The method as claimed in claim 4, wherein the image analysis comprises a determination of a weed type for the at least one weed.

6. The method as claimed in claim 1, wherein the remote flying sensing parameters are defined in the second step b) in that first a projected size of a single pixel of a smallest weed to be acquired on the ground is determined.

7. The method as claimed in claim 6, wherein the smallest weed to be acquired is determined on the basis of a size comparison of all identified weeds from the image analysis of the photographic recordings for each reference point.

8. The method as claimed in claim 6, wherein the remote flying sensing parameters comprise an altitude and camera properties and these are determined on the basis of the projected size of a single pixel of the smallest weed to be acquired on the ground.

9. The method as claimed in claim 1, wherein an image analysis of photographic remote flying sensing data acquired in a fourth step d) comprises a determination of at least one weed.

10. The method as claimed in claim 1, wherein, in a fourth step d), at least one weed distribution map for the field used for agriculture is created by means of an image analysis of photographic remote flying sensing data.

11. The method as claimed in claim 10, wherein an accuracy of the at least one weed distribution map is determined by comparison of the image analysis of the photographic remote flying sensing data and the image analysis of ground level sensing data at the reference points.

12. The method as claimed in claim 11, wherein the comparison of the image analysis of the photographic remote flying sensing data and the image analysis of the ground level sensing data at the reference points in the fourth step d) takes place in that it is checked whether at least one weed has been detected at a same geographic position of a reference point both in the image analysis of the photographic remote flying sensing data and in the image analysis of the ground level sensing data.

13. A system for collecting data on a field used for agriculture by a combination of remote flying and ground level sensing, comprising:
at least one measuring rod;
a receiving unit;
a computing unit; and
an output unit;
wherein, with the aid of the at least one measuring rod by ground level sensing, a geographic position of individual reference points on a field used for agriculture is acquired and for each reference point at least one photographic recording is made of at least one weed on the field used for agriculture,
wherein data from the reference points are provided to the computing unit via the receiving unit,
wherein the computing unit is configured to carry out an image analysis of photographic data of the respective reference points and to determine at least one weed for each reference point,
wherein the computing unit is configured to determine remote flying sensing parameters on the basis of the image analysis,
wherein the output unit is configured to display, output, or store in a data memory at least information from the computing unit with respect to the determination of remote flying sensing parameters.

14. A computer program product which, upon execution by a processor, is configured in such a way as to carry out the method as claimed in claim 1.

15. A measuring rod for collecting data by ground level sensing on a field used for agriculture, comprising:
at least one rod;
a sensor for determining a geographic position of individual reference points on the field used for agriculture;
a camera for photographically acquiring at least one weed for each reference point; and
output unit;
wherein the sensor for determining the geographic position and the camera are positioned on or at the rod so that the geographic position and the photographic recording can be determined or made at a reference point at the same point in time.
